(19) United States
(12) Patent Application Publication
(10) Pub. No.: US 2005/0114475 A1
(43) Pub. Date: May 26, 2005

(54) System and method for collaborative development environments

(76) Inventors: Hung-Yang Chang, Westchester County, NY (US); Fenno F. Heath III, New Haven County, CT (US); Hui Lei, Westchester County, NY (US); Jenny S. Li, Fairfield County, CT (US); Michael J. Dikun, Nassau County, NY (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/718,544

(22) Filed: Nov. 24, 2003

(51) Int. Cl. G06F 15/177

(52) U.S. Cl. 709/220

(57) ABSTRACT

A method and system for collaborative development environments allows members of a team which are physically separated to effectively work together. A Collaborative Development Environment (CDE) as a virtual space wherein all the stakeholders of a project—even if distributed by time or distance—may negotiate, brainstorm, discuss, share knowledge, and generally labor together to carry out some task, most often to create an executable deliverable and its supporting artifacts. The CDE allows people to interact with each other without shifting applications or transitioning to a different user interface, and the CDE encourages solving problems as they arise rather than waiting until the problem grows. The CDE may encompass a large variety of resources that range from role players and information items to tasks and development artifacts, but only those resources are relevant to a user's task at hand are presented.

### CROSS REFERENCE TO RELATED APPLICATION

This invention is related to the invention disclosed in copending patent application Ser. No. 10/______ filed Sep. 15, 2003, by Nitin Nayak, Fenno F. Heath III, Jenny S. Li, Hui Lei, Mitchell A. Cohen, Rakesh Mohan, Josef Schiefer, Stephen V. Stibler, Chung Sheng Li, and Maroun Touma for “A Method and System for Providing a Common Collaboration Framework Accessible from Within Multiple Applications” (IBM Docket YOR920030243US1), and assigned to a common assignee herewith. The disclosure of application Ser. No. 10/______ is incorporated herein by reference.

### BACKGROUND OF THE INVENTION

1. Field of the Invention

The present invention generally relates to collaborative data processing systems and, more particularly, to a method and system for collaborative development environments which allow members of a team which are physically separated to effectively work together.

2. Background Description

Collaboration is essential to every engineering domain. In the domain of software development, for example, software engineers on a project team must be able to effectively plan, share, clarify, negotiate, brainstorm, coordinate, build, and exchange information. Collaboration is even more important when the project team is physically distributed, which has become commonplace due to outsourcing, integration of third party software, increasing off-shore development, use of home offices, and strategic partnerships among companies, etc. The success of distributed teams working together effectively is imperative and is a distinguishing factor in the success or failure of many organizations.

Traditionally, most companies have engaged in people-to-people collaboration using technologies such as telephones, facsimile machines, electronic mail (e-mail), and in-person meetings. The last few years have seen the growth of collaboration technologies that leverage the power of the Internet. Such collaboration technologies, including instant messaging, electronic meetings (e-meetings), and team rooms, have been available primarily as standalone and general-purpose systems. There is no connection between the collaboration tools and development tools and environments. Developers have to manually switch between collaboration tools and development environments and are burdened to set up team rooms and meetings and to figure out the people with whom they need to interact.

### SUMMARY OF THE INVENTION

It is therefore an object of the present invention to provide a Collaborative Development Environment (CDE) as a virtual space wherein all the stakeholders of a project—even if distributed by time or distance—may negotiate, brainstorm, discuss, share knowledge, and generally labor together to carry out some task, most often to create an executable deliverable and its supporting artifacts.

Through its emphasis on seamless integration of collaborative features into the environment, the CDE allows people to interact with each other without shifting applications or transitioning to a different user interface. Further, the CDE encourages solving problems as they arise rather than waiting until the problem grows. It has the potential to yield a more productive, more satisfying development practice.

The CDE may encompass a large variety of resources that range from role players and information items to tasks and development artifacts. The combination of all these resources may be too voluminous for a human to keep track of. Further, not all resources are relevant to a user's task at hand. There is a need to associate resources with the applicable business context and model the interrelationships between resources. This way, the user is exposed to the relevant resources only, and is able to navigate between related resources. This effectively reduces the demand for human attention.

According to the invention, there is provided a method to build CDEs, based on explicit modeling of contexts and “CollabSpaces”. A context refers to the interrelated aspects of a business solution, within which collaboration may occur. A CollabSpace encapsulates the collection of collaboration of all resources and displays only those resources relevant to the current context of the user's development environment based on the role the user plays in the business process. Specifically, a collaboration space contains one or more collaboration elements that have potentially different collaboration modalities in association with a business context; e.g., role players, discussion threads, e-meetings, annotated documents, etc. The collaboration modalities refers to distinct collaboration capabilities provided by a specific technology, such as an e-meeting, discussion threads, instant messaging chat transcripts, online presence awareness (“buddy” lists), annotations, team rooms, etc. It provides a common substrate for members of a project team that use distinct development environments, each instrumented with a viewer to the CollabSpace. Further, the viewer presents a personalized view to different team members that is adapted to the members' current tasks and needs.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram illustrating the architecture of the contextual collaboration in a team environment according to the invention;

FIG. 2 is a screen print showing a preferred form of the collaboration plugin graphical user interface;

FIG. 2A is a screen print showing the pull-down menu which allows selection of the Manage Collab Space option; and

FIG. 3 is a flow diagram of the process implemented for the collaborative development environment.

### DETAILED DESCRIPTION OF A PREFERRED EMBODIMENT OF THE INVENTION

To create a Collaborative Development Environment, a virtual space where all stakeholders of a project can communicate both synchronously and asynchronously in a manner sensitive to the business context and user context, it is important to enable contextual collaboration within each team member's development environment.

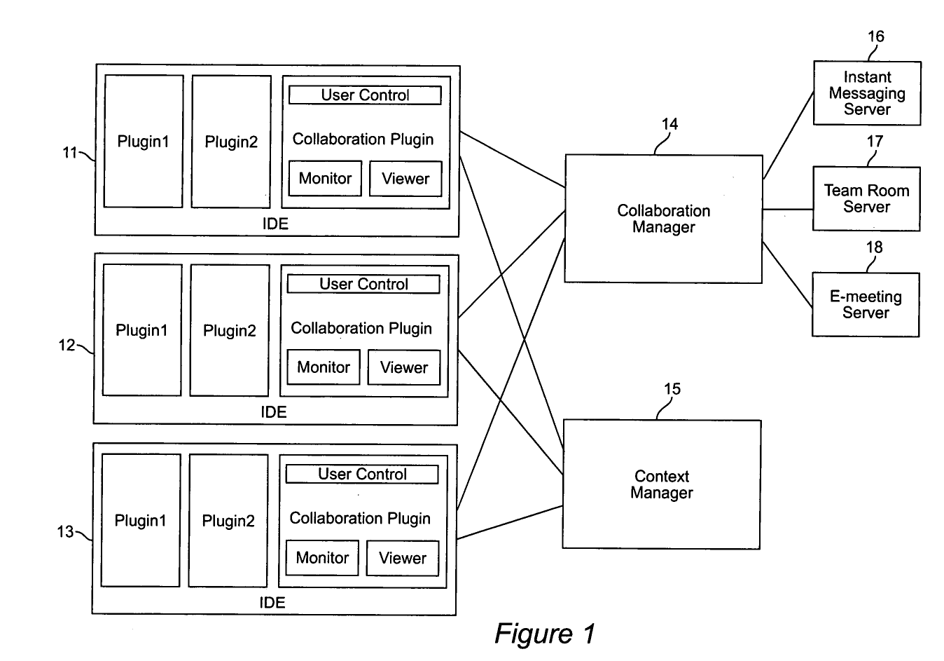

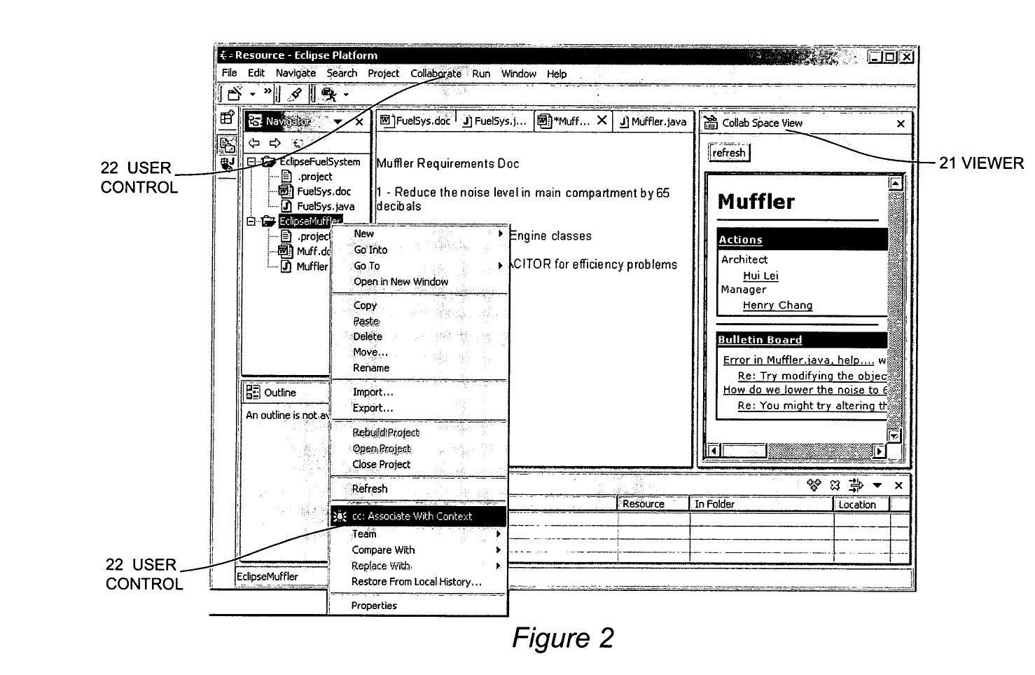

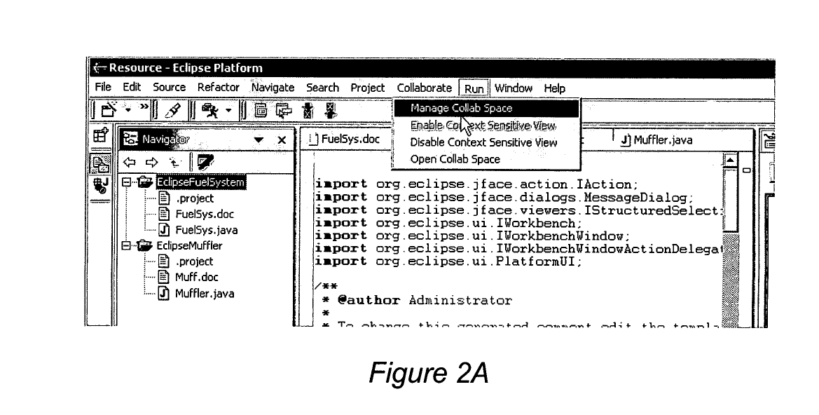

Referring now to the drawings, and more particularly to FIG. 1, there is shown the architecture of the contextual collaboration in a team environment according to the invention. In this example, there are three user Integrated Development Environment (IDEs) 11, 12 and 13, but it will be understood that the number of IDEs is solely dependent on the number of members of a particular team. An IDE is a software that provides users with a development environment that usually consists of a text editor, a compiler, an interpreter, some build automation tools, a debugger, and common version control system and optionally a graphical user interface (GUI) construction tool. The IDEs 11, 12 and 13 each comprise a number of plugins, including a Collaboration Plugin that adds collaborative capabilities (such as instant messaging, discussion threads, etc.) to allow the user to communicate with the stakeholders and gain access to resources of the projects he or she is working on without leaving his or her development environment or switching to a different collaboration application. The Collaboration Plugin includes a monitor, a viewer and user control, described in more detail with reference to FIGS. 2 and 2A.

In a team environment, it is very common that each team member has an IDE setup in his or her own workstation and each workstation is connected to a network. To facilitate the collaborative capabilities within a development, it is necessary to integrate collaboration tools with development tools through people collaboration activities. This is accomplished by means of the collaboration manager (CollabManager) 14 and the context manager (ContextManager) 15, details of which are provided in co-pending application Ser. No. 10/______. In this case, a Collaboration Plugin can be added to each member's IDE to facilitate communication among the team. The Collaboration Plugin allows users to connect to a ContextManager and CollabManager that hooks to any backend collaboration servers to provide users with collaboration capabilities. The ContextManager 15 manages contexts. Contexts are mechanisms to scope resource relationships, including relationships between collaboration elements and business operational artifacts. Resources and their interrelationships are specified with respect to a particular context. ContextManager 15 allows contexts to be created and further allows resources and relationships to be added to and removed from a context and, using an ontology engine, it answers queries about contextual relationships. On the other hand, CollabManager 14 facilitates the connections between the applications or development environments to the collaboration spaces and collaboration modalities. A collaboration space is a container of collaboration artifacts, including roles, members, collaborative activities, ad hoc modalities, and collaboration content. It is a mechanism for integrating disparate collaboration capabilities. CollabManager 14 provides the function of lifecycle management for collaboration spaces and directs modality-specific operations to external collaboration servers. The CollabManager 14, in this example, is connected to a Collaboration Plugin on each team member's IDE (three members total in this illustrative example) and the backend collaboration servers that include an instant messaging server 16, a team room server 17, and an e-meeting server 18.

In a CDE, a user is exposed to resources that store in a CollabSpace that are related to his or her context in the user's development environment based on the user's role. This is accomplished by means of the collaboration manager (“CollabManager”) 14 and the context manager (“ContextManager”) 15 (details of which again are provided in application Ser. No. 10/______). The ContextManger 15 manages the relationship between resources while CollabManager 14 facilitates the connection between the application or development environments to the collaboration spaces and collaboration modalities. The latter include, in this example, an instant messaging server 16, a team room server 17 and an e-meeting server 18.

Whenever the user's context changes, the appropriate resources will be shown automatically if the user wishes. The filtering of the right resources is a time saving advantage for the user since the user does not need to manually keep track of who or what is related to his current context, in particular, people interaction and effectiveness of teamwork are improved.

The integration of collaborative features within a business or within development applications and processes could be easier if there is a rapid development and deployment framework. The contextual collaboration framework according to the invention provides an on-demand add-on to any development environment. This leverages the plugin technology so that collaborative features are loosely coupled into the development environments upon business needs. It is also adaptive enough to expose the appropriate set of business artifacts to the user based on his role in the business process while this is integrated.

In a team environment, a team of developers, project manager, architects, testers and others may work together. Each may have their own development environment on different machines. Sometimes, project managers may use a different application to handle his work or tasks than the developers. In order for the team to collaborate with each other efficiently without switching to a separate collaboration tool, the Collaboration Plugin integrates a set of user controls, a viewer and a monitor in the development environment to allow both synchronous and asynchronous people collaboration to take place within the user's development tool. The user is able to see who is online, what resources are related to the current project the user is working on, what discussion topics are there, what e-meetings are available and so forth. FIG. 1 illustrates how the architecture of the Collaboration Plugin works in a team environment. Essentially, the Collaboration Plugin in each of IDEs 11, 12 and 13 is added to each team member's development environment, each Collaboration Plugin is able to talk to a common ContextManager 15 to bring the appropriate set of resources to the users, and a common CollabManager 14 to enable the people collaboration via instant messaging, team room, e-meetings, etc. Since the ContextManager 15 has the intelligence to bring the right resources that are related to the user's current working set, a user can collaborate with others without going through any hassle of starting another collaboration tool.

FIG. 2 is a screen print showing the Collaboration Plugin Graphical User Interface (GUI). This interface includes a Viewer 21 and User Control 22. The Viewer 21 is a graphic user interface component that can be added to a user's existing development environment to show the content of a selected CollabSpace. An example of content could be role players, discussion threads, e-meetings links, members online status, etc. Through the Viewer 21, the user is able to access the CollabSpace that is associated with the current context the user is working on, and start collaboration or interaction with fellow teammates.

User Controls 22 is a set of collaborative actions in a drop down menu format that the user could choose to perform within his or her development environment. Collaborative actions could be manage/open CollabSpace, associate with context or enable/disable context sensitivity for the collaboration Viewer 21. The collaboration Viewer 21 shows the appropriate content of the specific CollabSpace related to the current context of the user's development environment based on the role he or she plays in the business process. The context of the user's development environment could be a project, a subject or any logical grouping he chooses to use to categorize his work. Granularity of the context could differ from individual to individual. The association between the current context of the user's development environment and a specific CollabSpace is discussed below in the “Associate with Context” user control. FIG. 2A shows a similar screen print which illustrates the pull-down menu displayed by selecting the “Run” command from the command bar. One of the options provided to the user is “Manager Collab Space”.

To demonstrate how collaboration capabilities are enabled within the development environment, the following scenario is used. Consider a project as a form of context. UserA is currently working on ProjectA in his development environment like he usually does. Collaboration has not been started yet. To initiate interaction with his team members who work on the same project, he could perform the following user controls:
“Manage CollabSpace” user control—By choosing this control, he could further select to create a new CollabSpace. Upon the creation, he could either create a CollabSpace with for a new context or any existing context on the collaboration server. In this way, contexts could be associated in a hierarchical or parent and child manner. Assume CollabSpaceA is successfully created for the context his picked, he could add/edit/delete members and assign specific role to each for this CollabSpace.
“Associate with context” user control—By choosing this control, he could associate his current context that is working on, in this case ProjectA, to the context he picked for CollabSpaceA he just created. With this association, his current project, ProjectA, is associated with the context that CollabSpaceA is associated with. By the fact of transitivity, ProjectA is now related to CollabSpaceA.
“Enable Context Sensitive View” user control—When a user chooses this action, the Viewer 21 is now context sensitive. That is to say, the content displayed in the Viewer 21 is relevant to the current context the user is working on based on his role. In our example, UserA can see CollabSpaceA with relevant resources whenever he works on ProjectA.
“Disable Context Sensitive View” user control—A user can choose to disable the context sensitivity of the View if he choose this user control. The Viewer 21 will no longer be sensitive to the context he is working on. That is to say, a switch in context, for example from ProjectA to ProjectB, will not trigger the Viewer 21 to display relevant resources of the new context.
“Open CollabSpace” user control—A user can choose to manually open a CollabSpace if he wishes. Since the Viewer is now displaying a CollabSpace with resources that may or may not be relevant to the current context, the context sensitivity of the Viewer is disabled by this action.

The Monitor is a middleman behind the screen that listens to the actions of the user in his development environment and interfaces with CollabManager 14, ContextManager 15 and the Viewer 21 if the actions of the user are significant enough to change the current set of resources being CollabManager 14, ContextManager 15 and the Viewer 21 if the actions of the user are significant enough to change the current set of resources being displayed in the Viewer 21 if the user has enabled context sensitivity for the Viewer as mentioned above.

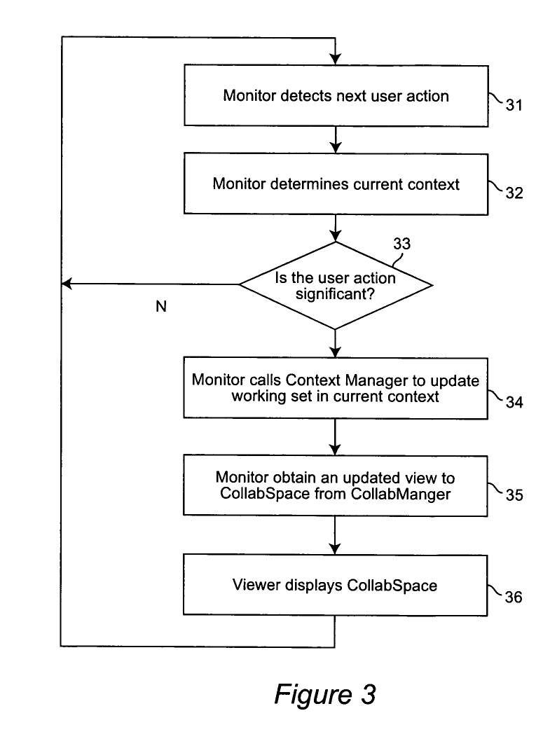

FIG. 3 depicts the flow of the Collaboration Plugin when context sensitivity of the Viewer 21 is enabled by user control. The Monitor always listens to the user's action, as indicated by function block 31. An example of action can be editing a file, expanding a directory, selecting a pull-down menu user control, etc. Based on the action of the user, the Monitor then determines in function block 32 the context associated with the action. In our example, UserA has two contexts: ProjectA and ProjectB, in his development environment. Both projects contain programming files and design documents. Say, UserA selects a design document to edit, the Monitor detects this action and finds the document is associated with ProjectB, i.e., the context. Since the Monitor keeps track of the current context information, it determines in decision block 33 if the user is switching to a new context by editing a file of ProjectB. In this case, assuming the user was working on ProjectA before, his new action has shown a change in context. The Monitor then sends a message to the ContextManager 15 in function block 34 and asks it to update the current context of the user to be ProjectB instead. ContextManager 15, in return, acknowledges the Monitor and reports of the resources that are associated with the new context. Since resources could differ from one context to another, the Monitor needs to inform CollabManager 14 in function block 35 to display the relevant resources of CollabSpace in the Viewer 21. Depending on the magnitude of the change in context, the Viewer 21 may display different resources from the same CollabSpace or resources from another CollabSpace in function block 36. The Monitor continues to capture the next user action, performs the same decision making procedures and

While the invention has been described in terms of a single preferred embodiment, those skilled in the art will recognize that the invention can be practiced with modification within the spirit and scope of the appended claims.

1. A system implementing a collaborative development environment among a team of developers, comprising:
a monitor that captures user and environment events;
a context manager that maintains relationships and resources within contexts; and
a viewer that presents collaboration elements based on a current developer context.

2. The system in claim 1, wherein the monitor and the viewer comprise a collaborative plugin to an integrated development environment that provides a user with tools for use in the development environment, there being a collaborative plugin for each user workstation.

3. The system in claim 2, wherein the collaborative plugin further comprises a user interface component adapted to define contexts and collaboration spaces.

4. The system in claim 1, wherein the context manager allows a context to be created, allows resources and relationships to be added to and removed from a context, and answers queries about contextual relationships.

5. The system in claim 2, further comprising a collaboration manager interfacing with collaborative plugins in a plurality of workstations to facilitate connection between application or development environments to collaboration spaces and collaboration modalities.

6. The system in claim 5, wherein the collaboration modalities include an instant messaging server, a team room server and an e-meeting server.

7. The system in claim 1, further comprising a collaboration manager that provides life cycle management functions of the collaboration spaces.

8. A computer implemented method to support collaborative development among a team of developers, comprising the steps of:
capturing user and development environments;
maintaining relationships and resources within contexts; and
presenting collaboration elements based on a current developer context.

9. The method in claim 8, further comprising the step of defining contexts and collaboration spaces.

10. The method in claim 8, wherein the steps of capturing and presenting are implemented by a collaborative plugin to an integrated development environment that provides a user with tools for use in the development environment, there being a collaborative plugin for each user workstation.

11. The method in claim 10, wherein the collaborative plugin further implements a user interface defining contexts and collaboration spaces.

12. The method in claim 8, wherein the step of maintaining relationships and resources within contexts includes the steps of creating a context, adding to and removing from a context resources and relationships, and answering queries about contextual relationships.

13. The method in claim 8, further comprising the step of facilitating connection between application or development environments to collaboration spaces and collaboration modalities.

14. The method in claim 9, further comprising the step of managing the life cycle of collaboration spaces.
